(19) United States
(12) Patent Application Publication
(10) Pub. No.: US 2008/0140314 A1
(43) Pub. Date: Jun. 12, 2008

(54) Device orientation navigation system for mobile electronic device

(76) Inventor: Kenneth J. Park, Cathlamet, OR (US)

Correspondence Address: SHARP LABORATORIES OF AMERICA, INC., 1320 PEARL ST., SUITE 228, BOULDER, CO, 80302, US

(21) Appl. No.: 11/634,684

(22) Filed: Dec. 6, 2006

(51) Int. Cl. G01C 21/00

(52) U.S. Cl. 701/213; 701/200

(57) ABSTRACT

A mobile electronic device and methods therefor convey direction to a location through output of audible or tactile signals in response to the spatial orientation of the mobile electronic device. A mobile electronic device in one embodiment comprises an input/output system, a navigation system and a processor operatively coupled with the input/output system and the navigation system, wherein under processor control the input/output system outputs at least one of an audible and tactile directional signal selected based on device orientation information determined using the navigation system.

### BACKGROUND OF THE INVENTION

The present invention relates to navigation systems for mobile electronic devices, and more particularly to navigation systems for mobile electronic devices that do not rely on a display map to convey a direction to a location.

Mobile electronic devices, such as cell phones, personal data assistants (PDA) and pocket PCs are known to include navigation systems that display a map showing a user's current location and a direction to a desired location. For example, mobile electronic devices are known to include a global positioning system (GPS) that displays a map having an “X” that indicates the user's location and an arrow to indicate the direction on the map from the user's location to the desired location. While effective in giving direction, such navigation systems typically require complex software and a high resolution display, and consume substantial memory. Moreover, such navigation systems typically require regular software updates to keep the map current.

### SUMMARY OF THE INVENTION

The present invention, in a basic feature, provides a mobile electronic device and methods therefor that convey direction to a location through output of audible or tactile signals in response to the spatial orientation of the mobile electronic device.

In one aspect of the invention, a mobile electronic device comprises an input/output system, a navigation system and a processor operatively coupled with the input/output system and the navigation system, wherein under processor control the input/output system outputs at least one of an audible and tactile directional signal selected based on device orientation information determined using the navigation system. The navigation system may continually monitor the device orientation information for changes and the input/output system may further output at least one of a modified audible and tactile directional signal selected based on modified device orientation information determined using the navigation system.

The device orientation information may comprise an actual device bearing determined using a compass and a target device bearing determined using a GPS system. The target device bearing may be further determined using target location information received on the input/output system as an input. The audible directional signal may comprise at least one of a tone and a frequency sweep. The tactile directional signal may comprise a vibration.

In another aspect of the invention, a method for conveying to a user of a mobile electronic device a direction to a location comprises the steps of receiving target location information as an input, determining a target device bearing based on the target location information, determining an actual device bearing based on an actual orientation of the device, determining at least one of an audio and tactile directional signal based on the actual device bearing and the target device bearing and outputting the directional signal from the device.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 illustrates how an angular difference used to determine an audible or tactile directional signal is calculated from an actual device bearing and a target device bearing.

FIG. 2 is a block diagram of a mobile electronic device in one embodiment of the invention.

FIG. 3 illustrates how a mobile electronic device rotates about an axis of rotation to reach a target device bearing in one embodiment of the invention.

FIG. 4 is a flow diagram of a method for conveying directional signals to a user of a mobile electronic device in one embodiment of the invention.

### DETAILED DESCRIPTION OF A PREFERRED EMBODIMENT

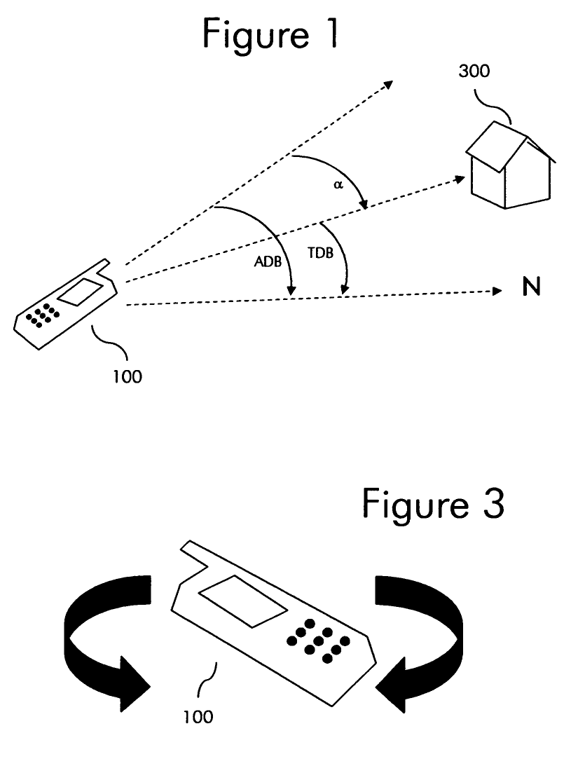

In one aspect of the present invention, a mobile electronic device guides its user to a target location by outputting audible and/or tactile directional signals based on angular differences between an actual device bearing and a target device bearing. FIG. 1 illustrates how an angular difference a is calculated from an actual device bearing ADB and a target device bearing TDB. Device 100 calculates the actual device bearing ADB as the horizontal angular distance measured clockwise from a first imaginary line extending from device 100 along its longitudinal axis and a second imaginary line interconnecting device 100 and true north. Device 100 calculates the target device bearing TDB as the horizontal angular distance measured clockwise from a first imaginary line interconnecting device 100 and a target location 300 and a second imaginary line interconnecting device 100 and true north. Device 100 then calculates the angular difference α between the actual device bearing ADB and the target device bearing TDB. An appropriate audible and/or tactile output is then selected as a function of the angular difference α.

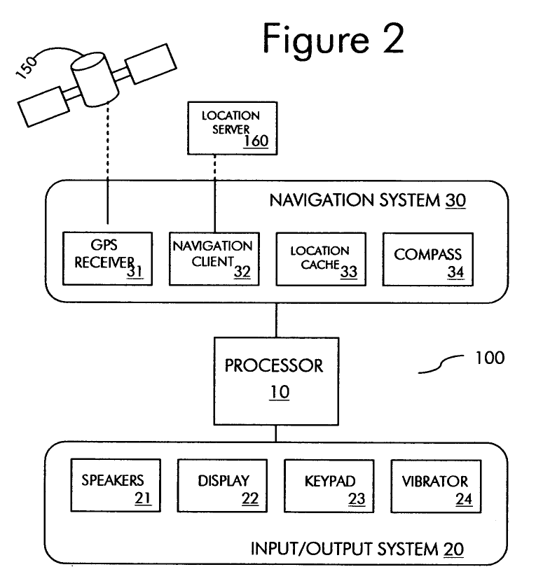

Turning to FIG. 2, device 100 is shown in more detail. Device 100 may be a cellular phone, an Internet Protocol (IP) phone, a PDA or a pocket PC, for example. Device 100 includes a processor 10 communicatively coupled with an input/output (I/O) system 20 and a navigation system 30. Processor 10 is a general purpose microprocessor having operating system software running thereon. Processor 10 executes software applications and manages interactions between elements of I/O system 20 and navigation system 30.

I/O system 20 includes speakers 21, a display 22, a keypad 23 and a vibrator 24. Speakers 21 include a left speaker and a right speaker for providing audio output signals from device 100 at various tones and volumes including stereo output signals. Display 22 is a screen, such as an LCD screen, for visually rendering inputs received on keypad 23 and outputs from device 100. Keypad 23 includes keys for accepting inputs on device 100. Inputs on device 100 include target locations, such as popular site names and street addresses. Keypad 23 in some embodiments is a 12-key telephonic keypad supplemented with soft keys. Vibrator 24 is an electromechanical device that provides tactile output signals from device 100 in the form of vibrations of various intensities.

Navigation system 30 includes GPS receiver 31, navigation client 32, location cache 33 and compass 34. GPS receiver 31 continually receives position information from GPS satellites 150 and computes the actual position of device 100 based thereon. The actual position includes a longitudinal and latitudinal coordinate. The actual position is transmitted to navigation client 32.

Location cache 33 is a database on device 100 having mappings between select target locations and target positions. Location server/database 160 is a remote server/database having mappings between target locations not known on location cache 33 and target positions. Target locations include popular site names and street addresses. Target positions include longitudinal and latitudinal coordinates associated with target locations. In some embodiments, mappings are configured statically on location cache 33 through inputs on keypad 23. In some embodiments, in lieu of or in addition to static configuration, mappings are configured dynamically on location cache 33 by navigation client 32 upon resolving target locations to target positions through resort to location server/database 160. In that way, if the some target location is entered a second time it can be resolved to a target position without further resort to location server/database 160. In some embodiments, dynamically configured mappings time-out of location cache 33 after a predetermined period. Location cache 33 may be implemented in random access memory (RAM).

Moreover, in some embodiments, a user may through inputs on keypad 23 provide a site name or street address of his or her current location and instruct navigation client 32 to create a mapping on location cache 33 between the name or address and the actual position received from GPS receiver 31. In that way, the mapping becomes stored locally for later use when the user wishes to return to the current location.

Compass 34 is a flux gate compass that continually computes the actual device bearing as described above in connection with FIG. 1. The actual device bearing is transmitted to navigation client 32.

Navigation client 32 receives target locations input on keypad 23 and interfaces with one or more of location cache 33 and location server/database 160 to resolve the target locations to target positions. Navigation client 32 first checks whether a target location has a mapping in location cache 33. If so, navigation client 32 uses that mapping to resolve the target position. If not, navigation client 32 consults the target location mapping in location server/database 160 to resolve the target position.

Navigation client 32 receives the actual position from GPS receiver 31. Navigation client 32 continually determines the target device bearing from the actual position and the target position as described above in connection with FIG. 1.

Navigation client 32 receives the actual device bearing from compass 34. Navigation client 32 continually determines the angular difference between the actual device bearing and the target device bearing. Navigation client 32 then continually selects an appropriate audible and/or tactile directional signal based on angular difference. Navigation client 32 implements algorithms for selecting appropriate audible and/or tactile directional signals as a function of angular differences.

FIG. 3 illustrates how device 100 rotates about an axis of rotation to reach a target device bearing in some embodiments of the invention. A user holds device 100 in a generally horizontal position and rotates device 100 clockwise or counterclockwise to change the actual device bearing. The rotation causes a change in the angular difference between the actual device bearing and the target device bearing, which results in a change in the audible and/or tactile directional signal output from device 100. The change in the audible and/or tactile directional signal informs the user whether the actual device bearing is getting closer or farther from the target device bearing, that is, whether the angular difference between the actual device bearing and the target device bearing is decreasing or increasing. The change in the audible and/or tactile directional signal also informs the user when the target device bearing has been reached, that is, when the angular difference is zero or near-zero.

In one such embodiment, an audible directional signal is a tone that loudens as the actual device bearing gets closer to the target device bearing and softens as the actual device bearing gets farther from the target device bearing. In such an embodiment speakers 21 have the ability to output tones at various volumes based on algorithmic calculations made by navigation client 32. To inform the user that the shortest angular distance to the target device bearing is clockwise, speakers 21 emit tones that are progressively louder as device 100 is rotated clockwise and emit tones that are progressively softer as device 100 is rotated counterclockwise. Similarly, to inform the use that the shortest angular distance to the target device bearing is counterclockwise, speakers 21 emit tones that are progressively louder as device 100 is rotated counterclockwise and emit tones that are progressively softer as device 100 is rotated clockwise.

In another such embodiment, a tactile directional signal is a vibration that increases in intensity as the actual device bearing gets closer to the target device bearing and decreases in intensity as the actual device bearing gets farther from the target device bearing. In such an embodiment vibrator 24 has the ability to output vibrations of various intensities based on algorithmic calculations made by navigation client 32. To inform the user that the shortest angular distance to the target device bearing is clockwise, vibrator 24 emits vibrations that are progressively stronger as device 100 is rotated clockwise and emits vibrations that are progressively weaker as device 100 is rotated counterclockwise. Similarly, to inform the user that the shortest angular distance to the target device bearing is counterclockwise, vibrator 24 emits vibrations that are progressively stronger as device 100 is rotated counterclockwise and emits vibrations that are progressively weaker as device 100 is rotated clockwise.

In still other embodiments, a repetitive audible and/or tactile directional signal informs the user the whether to rotate device 100 clockwise or counterclockwise to reduce the angular difference between the actual device bearing and the target device bearing. A change in the audible and/or tactile directional signal then informs the user when the target device bearing has been reached, that is, when the angular difference is zero or near zero.

In one such embodiment, an audible directional signal is a frequency sweep that informs the user whether to rotate device 100 clockwise or counterclockwise to reach the target device bearing. Speakers 21 include a left and right speaker having the ability to output tones at any fixed interval within a range, for example 10 Hz intervals within a 1000-2000 Hz range. To inform the user that the shortest angular distance to the target device bearing is clockwise, the left speaker outputs a series of tones at all fixed intervals starting at the lowest frequency in the range, for example 1000 Hz, and ending at a mid-range frequency, for example 1500 Hz, over a first duration, such as two seconds. Immediately thereafter, the right speaker outputs a series of tones at all fixed intervals starting at the next mid-range frequency, for example 1510 Hz, and ending at the highest frequency, for example 2000 Hz, over a second duration, such as two seconds. As a result of this sound sequence the user hears a sweeping noise from left to right that informs the user to rotate device 100 in the clockwise direction. Once device 100 is rotated and reaches the target device bearing, the frequency sweep stops and speakers 21 output a common tone. The order and direction of the sequence is reversed to inform the user that the shortest angular distance to the target device bearing is counterclockwise. Naturally, the frequency sweep may be achieved using other tonal sequences. For example, speakers 21 may output the some sequence of tones at the same time and speaker volume may be manipulated such that the left speaker is louder during a first duration while the right speaker is louder during a second duration. Moreover, other frequencies and durations may be used.

In still other embodiments, audible and tactile directional signals may be used in tandem. For example, rotation toward the target device bearing may result in simultaneous output by device 100 of a loudening tone and an increasing vibration.

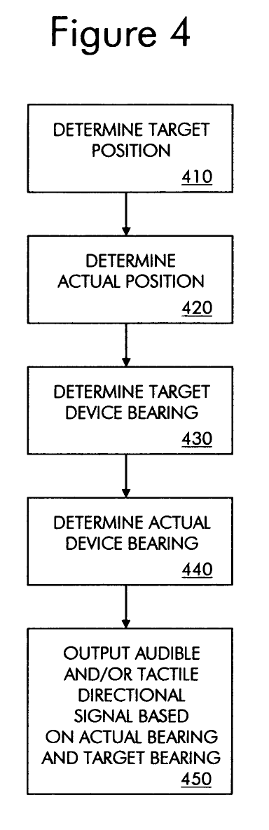

In FIG. 4, a flow diagram illustrates a method for conveying directional signals to a user of device 100 in one embodiment of the invention. Device 100 determines a target position (410). The user inputs a target location, such as a popular site name or a street address, on keypad 23. Navigation client 32 receives the target location and looks-up the target location in location cache 33. If there is a mapping for target location in location cache 33, navigation client 32 uses the mapping to resolve the target position. If there is no mapping for the target location in location cache 33, navigation client 32 consults location server/database 160 to resolve the target position. The target position includes a longitude and latitude of the target location.

Device 100 continually determines its actual position (420). GPS receiver 31 continually receives position information from GPS satellites 150 and computes an actual position of device 100 based thereon. The actual position includes a longitude and latitude of device 100. The actual position is transmitted to navigation client 32.

Device 100 continually determines a target device bearing (430). Navigation client 32 continually determines the target device bearing from the actual position received from GPS receiver 31 and the target position resolved using location cache 33 or location server/database 160. The target device bearing is computed as the horizontal angular distance measured clockwise from a first imaginary line interconnecting the actual position and the target position and a second imaginary line interconnecting the actual position and true north.

Device 100 continually determines an actual device bearing (440). Compass 34 computes the actual device bearing as the horizontal angular distance measured clockwise from a first imaginary line extending from the top of device 100 along the longitudinal axis of device 100 and a second imaginary line interconnecting the actual position of device 100 and true north. The actual device bearing is transmitted to navigation client 32.

Device 100 continually outputs an audible and/or tactile directional signal based on the actual device bearing and the target device bearing (450). Navigation client 32 receives the actual device bearing from compass 34 and determines the angular difference between the actual device bearing and the target device bearing. Navigation client 32 then continually determines an appropriate audible and/or tactile directional signal based on the angular difference.

In some embodiments, device 100 supports multiple types of directional signals and the user selects a preferred one of the types through inputs on keypad 23.

I/O system 20 and navigation system 30 may be implemented using various combinations of custom logic and software. In some embodiments, GPS receiver 31 is implemented in custom circuitry and navigation client 32 is a software application executed by processor 10.

It will be appreciated by those of ordinary skill in the art that the invention can be embodied in other specific forms without departing from the spirit or essential character hereof. For example, in some embodiments navigation system 30 may use an alternative approach to determining the actual position of device 100, such as triangulation between three cellular towers or an approach wherein device 100 sends raw GPS data to a remote server for calculating the actual position of device 100. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A mobile electronic device, comprising:
an input/output system;
a navigation system; and
a processor operatively coupled with the input/output system and the navigation system, wherein under control of the processor the input/output system outputs at least one of an audible and tactile directional signal selected based on device orientation information determined using the navigation system.

2. The device of claim 1, wherein the navigation system continually monitors the device orientation information for changes and input/output system further outputs at least one of a modified audible and tactile directional signal selected based on modified device orientation information determined using the navigation system.

3. The device of claim 1, wherein the device orientation information comprises an actual device bearing determined using a compass and a target device bearing determined using a GPS system.

4. The device of claim 1, wherein the target device bearing is further determined based on target location information received on the input/output system as an input.

5. The device of claim 4, wherein the target location information is resolved to a target position and wherein the target device bearing is determined based on the target position.

6. The device of claim 5, wherein the target location information is resolved to a target position through consultation of a location cache on the device.

7. The device of claim 5, wherein the target location information is resolved to a target position through consultation of a remote location server/database.

8. The device of claim 1, wherein the audible directional signal comprises a tone.

9. The device of claim 1, wherein the audible directional signal comprises a frequency sweep.

10. The device of claim 1, wherein the tactile directional signal comprises a vibration.

11. The device of claim 1, wherein the device simultaneously outputs an audible directional signal and a tactile directional signal.

12. A method for conveying to a user of a mobile electronic device a direction to a location, comprising the steps of:
receiving target location information as an input on the device;
determining a target device bearing based on the target location information;
determining an actual device bearing based on an actual orientation of the device;
determining an audio directional signal based on the actual device bearing and the target device bearing; and
outputting the audio directional signal from the device.

13. The method of claim 12, wherein the actual device bearing is continually determined and the audio directional signal is continually modified in response to changes in the actual device bearing.

14. The method of claim 12, wherein the actual device bearing is determined using a flux gate compass.

15. The method of claim 12, wherein the target device bearing determined using a GPS system.

16. The method of claim 12, wherein the audio directional signal comprises a tone.

17. The method of claim 12, wherein the audio directional signal comprises a frequency sweep.

18. A method for conveying to a user of a mobile electronic device a direction to a location, comprising the steps of:
receiving target location information as an input on the device;
determining a target device bearing based on the target location information;
determining an actual device bearing based on an actual orientation of the device;
determining a tactile directional signal based on the actual device bearing and the target device bearing; and
outputting the tactile directional signal from the device.

19. The method of claim 18, wherein the actual device bearing is continually determined and the tactile directional signal is continually modified in response to changes in the actual device bearing.

20. The method of claim 18, wherein the tactile directional signal comprises a vibration.
